(19) United States
(12) Patent Application Publication
(10) Pub. No.: US 2013/0036839 A1
(43) Pub. Date: Feb. 14, 2013

(54) FLAME ATMOSPHERE ANALYSER

(71) Applicants: Michele Bortoliero, Monselice (PD) (IT); Manuel Salmaso, Battaglia Terme (PD) (IT)

(72) Inventors: Michele Bortoliero, Monselice (PD) (IT); Manuel Salmaso, Battaglia Terme (PD) (IT)

(73) Assignee: SIT LA PRECISA S.p.A., Padova (IT)

(21) Appl. No.: 13/643,156

(22) PCT Filed: Mar. 25, 2011
(86) PCT No.: PCT/EP2011/054605

§ 371 Date: Oct. 26, 2012

(30) Foreign Application Priority Data
Apr. 28, 2010 (IT) PD2010A000132

(51) Int. Cl. G01N 1/22

(52) U.S. Cl. 73/863.81

(57) ABSTRACT

A flame atmosphere analyzer is described, for operation with combustible gases, including a tube in which an intake and air and gas mixing chamber is formed, a first gas supply nozzle and means for supplying primary combustion air opening into said intake chamber, and a flame burner in fluid communication with the intake and mixing chamber for supplying an air and gas mixture, formed in the chamber, to the burner. The analyzer includes a second gas supply nozzle, which is slidably guided in the tube, and an actuator provided on the tube and operable from outside the tube, for moving the second nozzle between an inoperative first position, in which the gas is supplied through the first nozzle, and an operational second position, in which the gas is supplied through the second nozzle, the first nozzle having no effect on the supply of the gas in the second position.

### TECHNICAL FIELD

The present invention relates to a flame atmosphere analyser having the characteristics stated in the preamble to claim 1, which is the principal claim.

### TECHNOLOGICAL BACKGROUND

The invention relates particularly, although not exclusively, to the field of flame atmosphere analysers used for controlling the ignition of gas burners. Typical applications are those in which the burners are provided in apparatus with open combustion chambers for space heating or for domestic water heating.

These analysers are used not only for ignition and flame monitoring, for the purpose of preventing leakage of unburnt gases, but also for intercepting the gas supply when the oxygen content in the combustion air falls below a safe level, or when the content of carbon dioxide increases. These analysers are designed for use with air and gas mixing ratios which create a relatively unstable flame, which may become detached when the oxygen content of the air varies.

There is also a known way of using flame atmosphere analysers of the aforesaid type in burners for use with combustible gases of different types, such as natural gas and liquefied gas; these gases differ in their characteristics and combustibility and consequently require different calibrations or configurations of the analyser for operation with one or other of the gases.

In particular, a separate nozzle is required for each type of gas used, and a specific and different quantity of primary air has to be conveyed to the region for mixing with the gas to ensure correct combustion at the burner.

In some known solutions, the nozzle is changed to suit the gas which is used, but this operation has to be performed by specialist personnel who must check the choice of components and their assembly for correct operation of the device. In another known solution, opposing tubes are used, each tube being dedicated to use with a specific combustible gas, but this design is rather complicated and expensive as regards the components required and their assembly.

There is also a known way of providing a Y-shaped analyser tube structure, in other words a structure with a tube provided with passages converging in a common end region, but this design is also complicated and expensive.

### DESCRIPTION OF THE INVENTION

The primary object of the invention is to provide a flame atmosphere analyser which is structurally and functionally designed so as to be rapidly convertible in use with gases of different kinds, and which is safe, without requiring any replacement of components, thus ensuring safe operation of the apparatus without the need for adjustment by the operator.

The invention achieves this object by means of a flame atmosphere analyser made in accordance with the following claims.

### BRIEF DESCRIPTION OF THE DRAWINGS

Other features and advantages of the invention will become clear from the following detailed description of a preferred example of embodiment thereof, illustrated, for the purpose of illustration and in a non-limiting way, in the attached drawings, in which:

FIG. 1 is a perspective view of a flame atmosphere analyser made according to the present invention,

FIG. 2 is an exploded perspective view of the analyser of FIG. 1,

FIG. 3 is a view in axial section of the analyser of the preceding figures,

FIG. 4 is a plan view of the analyser of FIG. 3,

FIGS. 5 and 6 are views in axial section of the analyser of the preceding figures in different operating positions,

FIGS. 7 and 8 are enlarged sectional views of details of FIGS. 5 and 6 respectively.

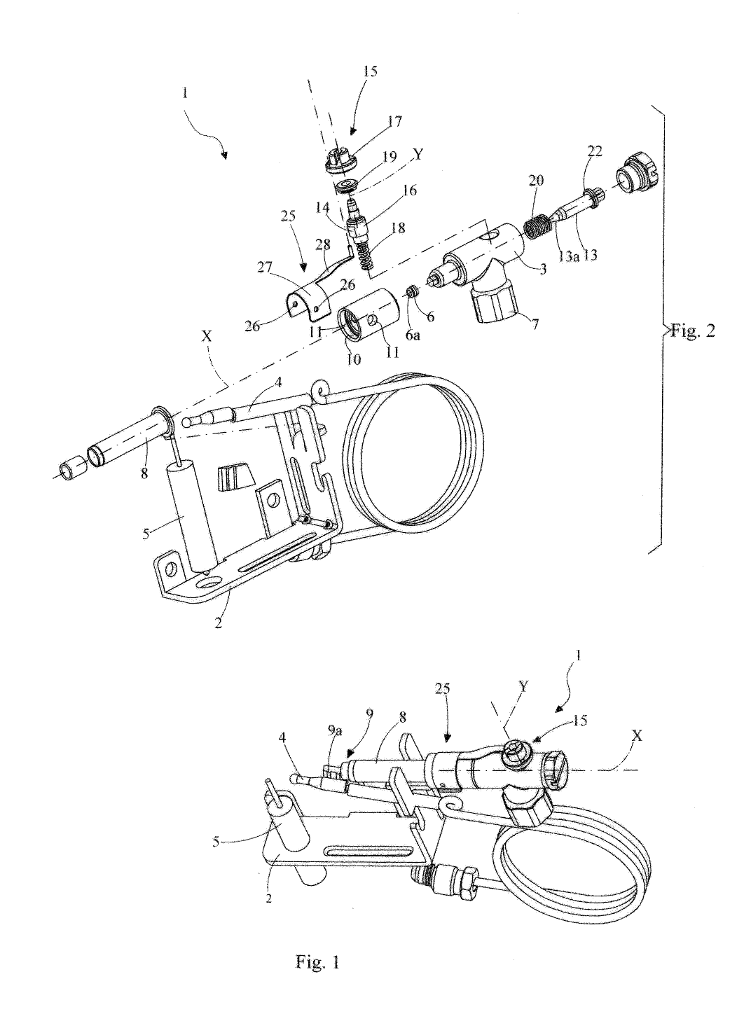

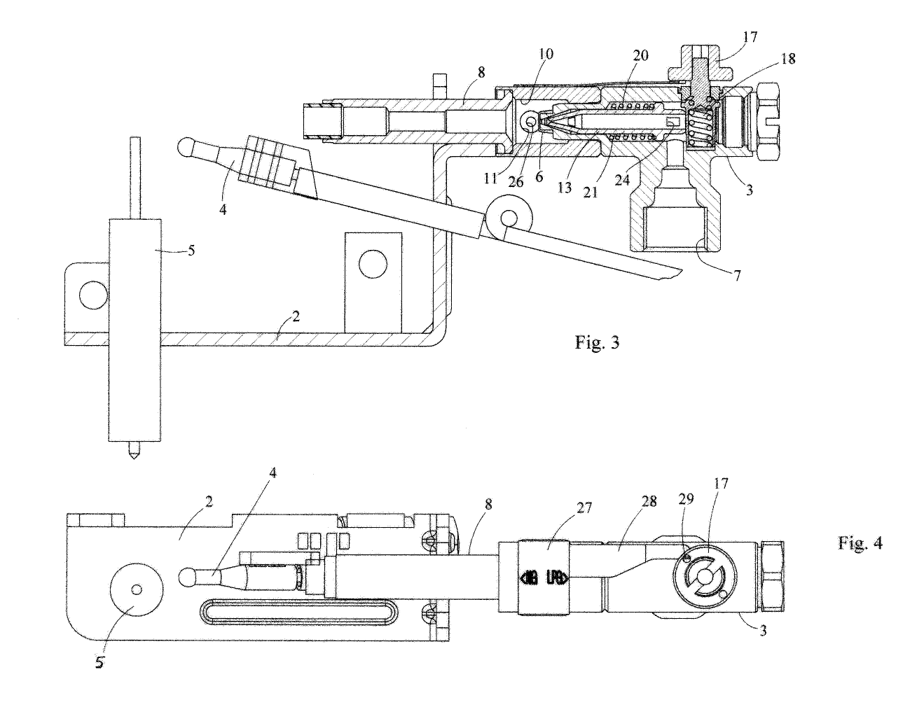

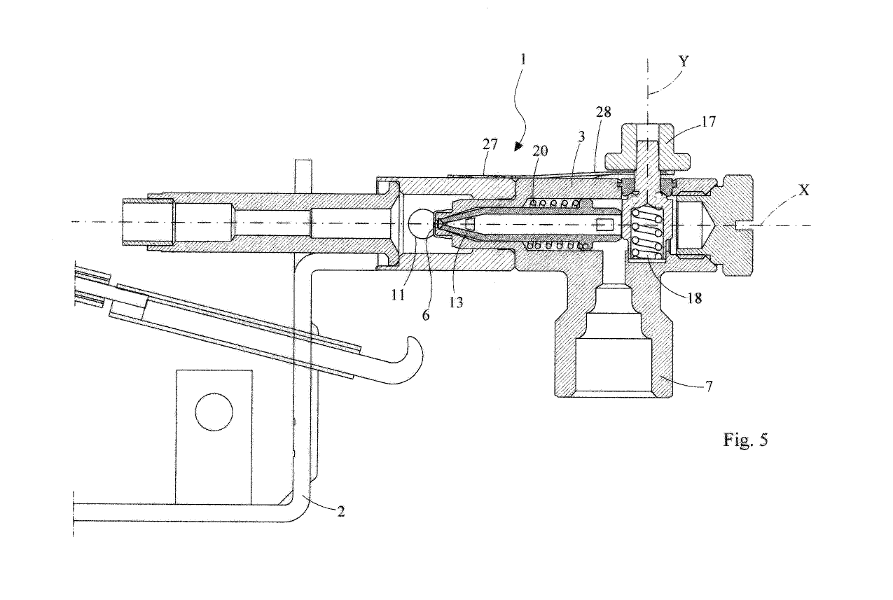

### PREFERRED EMBODIMENT OF THE INVENTION

With reference to the aforesaid drawings, the number 1 indicates the whole of a flame atmosphere analyser made according to the present invention.

The analyser 1 comprises a support 2 on which are fixed a tube 3, a thermocouple flame detection device 4 and a spark igniter 5 for igniting the flame.

The tube 3 has an internally hollow tubular shape and is provided at one of its axial ends with a first combustible gas supply nozzle 6 having a corresponding delivery orifice 6a. The tube opens at its opposite end into a gas inlet section 7 and is extended at the opposite end into a tubular conduit 8 on which a burner head 9 with a flame nozzle 9a is fitted.

An intake and mixing chamber 10 is formed in the tubular conduit 8, at the position of the nozzle 6, this chamber being coaxial with the nozzle 6 and in fluid communication therewith, and having a pair of holes 11 passing through the shell of the conduit 8 and positioned on diametrically opposite sides, the primary air being supplied through these holes into the intake and mixing chamber 10. The analyser 1 also comprises, according to a principal feature of the invention, a second nozzle 12, having a corresponding supply hole 12a, mounted slidably in the tube 3 and coaxial therewith, as described more fully below.

The second nozzle 12 is provided at one end of an internally hollow tubular body 13 whose opposite axial end is in contact with a cam-shaped surface profile 14 of an actuator means, indicated as a whole by 15, which is supported rotatably in the tube and by means of which the tubular body, together with the nozzle 12, can be moved between an inoperative first position, in which the gas is supplied through the first nozzle 6, and an operational second position in which the gas is supplied through the second nozzle 12, the first nozzle 6 having no effect on the gas supply in this operational second position.

The actuator means comprise a sleeve formation 16 mounted rotatably in the tube 3 about an axis of rotation Y, lying perpendicular to the axial direction of development of the tube 3, indicated by X, the cam profile 14 being formed on the outer shell of the sleeve 16 so as to interact with the corresponding end of the tubular body 13. The sleeve formation 16 is fixed to a control knob 17 accessible from outside the tube 3, by means of which the sleeve 16 of the actuator means can be rotated, thus causing, as a result of the rotation of the cam 14, an axial movement of the nozzle 12 between the aforesaid positions. The number 18 indicates a spring which is provided inside the sleeve 16 and which can press the sleeve against a closure element 19 provided in the tube 3, with the interposition of a gasket (not shown). The resilient action of the spring 18 serves to position the sleeve formation 16 in the tube, with a gas-tight seal between the inside and outside.

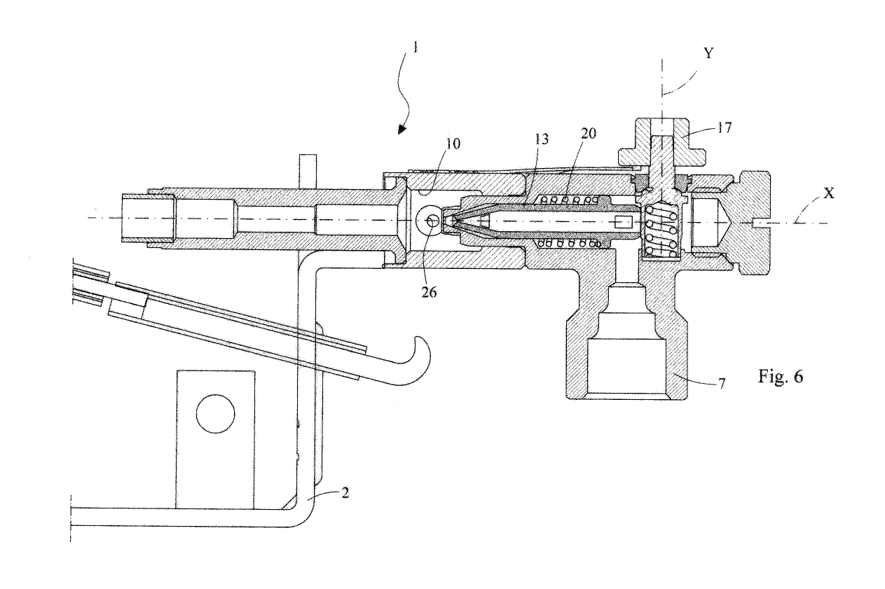

The number 20 indicates a further spring fitted on the tubular body 13 and acting between a pair of shoulders 21 and 22 provided in the tube 3 and in the tubular body 13 respectively, the spring 20 acting as a return means for the body 13 by holding the latter in contact with the sleeve formation 16, while also causing, by the resilient return action of the spring, the return of the nozzle 12 into the inoperative first position which is distant from the first nozzle 6. The nozzle 12 is provided at the end of the tubular conduit 13, in a portion 13a of the conduit which has a conical shape and is housed in a portion 3a of the tube which also has an internally conical shape, tapering towards the first nozzle 6. The cone angles of the facing portions 3a and 13a are such that, in the inoperative first position (in which the gas is supplied from the nozzle 6), the conical portions of the body 13 and of the tube 3 remain spaced apart (as shown in FIG. 6) and gas can flow through the annular volume delimited by the facing conical surfaces. In this condition, the gas flows inside the tube both inside and outside the tubular body 13, and also through holes 23 and 24 in the tubular body 13, until it reaches the first nozzle 6, through which the gas is supplied to the chamber 10.

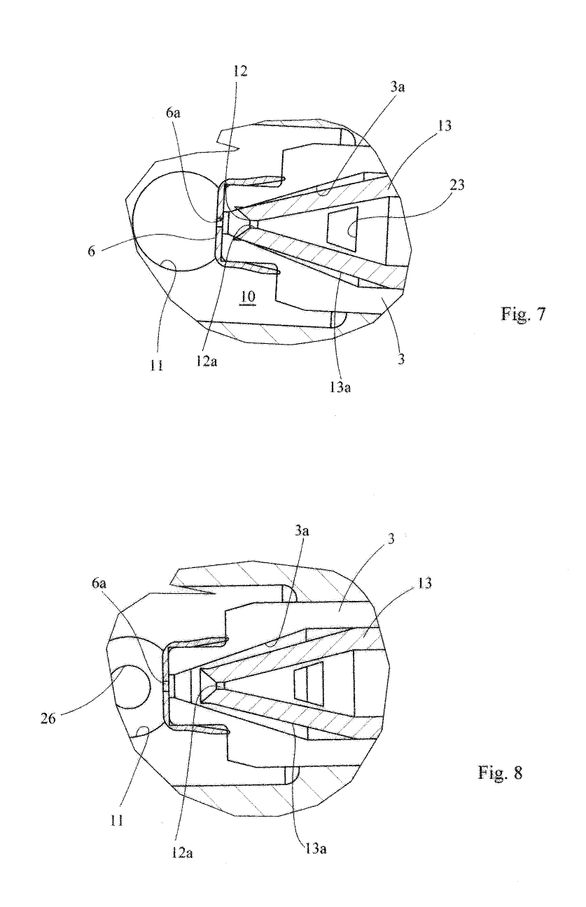

In the operational second position, the cone angles of the aforesaid portions, which are different from each other, are such that the conical portion of the body 13 is in localized surface contact with the inner conical surface of the corresponding portion of the tube 3 (as shown in FIG. 7). In this condition, the whole flow of gas in the tube passes through the nozzle 12, through which the gas is supplied to the chamber 10. Since the hole 12a of the nozzle 12 has a smaller cross section than the hole 6a, the nozzle 6 has no effect on the supply in this operational condition.

The analyser 1 is provided with means for dividing the primary air, indicated as a whole by 25, which are incorporated into the analyser and connected for operation to the actuator means 15 in such a way that, in the first and second operating positions, they are moved, by the operation of the selection knob 17, from and towards the holes 11 for the admission of gas into the chamber 10, to provide a predetermined admission of primary air into the chamber 10, adapted to the corresponding nozzle activated by the selector knob.

More particularly, the divider means comprise a pair of holes 26 passing through a strip 27 which has an approximately semicylindrical shape and which is such that it can be fitted and retained slidably on the cylindrical shell of the tube 3. The strip is extended into a lever 28 whose free end is connected pivotably at 29 to the knob 17, at a predetermined distance from the axis Y and the pivot point, in such a way that a rotation of the knob 17 is converted into a translation of the strip 27 in the axial direction X, by means of the aforesaid connection of the lever mechanism 28.

The passage cross section of the holes 26 is smaller than the cross section of the holes 11.

In the first operating position (FIG. 8) in which the gas is supplied from the nozzle 6, the divider strip 27 is positioned with the holes 26 superimposed on the holes 11, preferably coaxially, in such a way that the aperture for the admission of the primary air into the chamber 10 is determined by the holes 26. Conversely, in the second operating position, in which the rotation of the knob activates the nozzle 12 and simultaneously moves the strip 27 away from the holes 11, without any division of the holes, the admission of the primary air into the chamber 10 takes place through the passage cross section determined by the holes 11.

By designing the nozzles 6, 12 and the admission holes 11, 26 with suitable dimensions, the analyser can be made to operate correctly with different gases. In the example which has been described the nozzle 6 and the holes 26 are chosen for operation with natural gas, while the nozzle 12 and the holes 11 are chosen for operation with liquid gas.

In operation, the first or second operating position is selected by means of the control knob 17, these positions being illustrated, respectively, in FIGS. 6, 8 (natural gas) and FIGS. 5, 7 (liquefied gas), the change from one position to the other being made solely by the rotation of the selector knob 17, which can act simultaneously on the nozzle 12 and the primary air divider means 25 to move them between the aforesaid positions.

Thus the invention achieves the proposed objects while yielding numerous advantages by comparison with the known solutions.

A primary advantage is that the analyser can be used with different gases without the need for any substitution of components, which would require corresponding assembly and disassembly; consequently, the change from one operating mode to the other is extremely rapid.

Furthermore, a change from one function to the other does not require any tests or calibration other than those specified initially, whereas these would be required in the known solutions in which components are changed.

Because of the invention, the positions assumed in changes between the specified functions are also predetermined and not subject to alteration, and are therefore extremely safe for the use of the analyser with gases of different kinds.

Additionally, because the movement of the actuator means for activating the chosen nozzle and for moving the divider means is synchronized and is produced with a single selector knob, the analyser setting procedure is simplified and is made safe and rapid for the user.

1. A flame atmosphere analyzer, for operation with combustible gases, comprising:
a tube (3) in which an intake and air and gas mixing chamber (10) is formed,
a first gas supply nozzle (6) and means (11) of supplying primary combustion air, said means opening into said intake chamber (10),
a flame burner (9) in fluid communication with said intake and mixing chamber (10), enabling an air and gas mixture, formed in said chamber, to be supplied to said burner, and
a second gas supply nozzle (12), which is slidably guided in said tube (3), and actuator (15) provided on the tube (3) and operable from outside the tube, for moving said second nozzle (12) between an inoperative first position, in which the gas is supplied through said first nozzle (6), and an operational second position, in which the gas is supplied through said second nozzle (12), the first nozzle (6) having no effect on the supply of the gas in said second position.

2. The analyzer according to claim 1, wherein said first and second nozzles (6, 12) are configured to enable the analyzer to be used with natural gas and with liquefied gas respectively.

3. The analyzer according to claim 1, wherein said second nozzle (12) is provided at the end of a tubular body (13) which is slidably guided in the tube (3) and through which the gas to be supplied through the second nozzle (12) in said operational second position is made to flow, said actuator (15) comprising a cam (14) supported rotatably in the tube (3) and acting on said tubular body (13) to move it from and towards said operational second position, in opposition to a resilient return means (20), said cam (14) being operable by a control knob (17) accessible from outside the tube (3).

4. The analyzer according to claim 3, wherein said cam (14) is supported rotatably in the tube (3) about an axis (Y) of rotation lying perpendicular to the axial direction (X) of sliding of the tubular body carrying the second nozzle (12).

5. The analyzer according to claim 4, wherein a cam profile (14) of said means (15) is formed on a sleeve formation (16) which is connected to the control knob (17) and is pressed by the resilient action of a further spring (18) against an element (19) fixed to the tube (3), to ensure a gas-tight seal between surfaces which are in contact with each other and which move relative to each other as a result of the rotation of the control knob (17).

6. The analyzer according to claim 5, wherein a primary air divider (25) provided, which is incorporated into the tube and connected for operation to said actuator (15), in such a way that in said first and second operating positions the divider (25) is moved in a corresponding way from and towards said primary air supply means (11) to provide a predetermined inflow of primary air into said mixing chamber (10) as required by the corresponding nozzle for the gas which is used.

7. The analyzer according to claim 6, wherein said divider (25) is connected for operation to said actuator (15) in such a way that the divider (25) moves in synchronization with the actuator (15).

8. The analyzer according to claim 7, wherein said primary air supply means comprise at least one first through hole (11) opening into said chamber, and said divider comprises a strip (27), having at least one second hole (26), which can be moved along the tube (3) from and towards an operating condition in which the at least one second hole (26) is superimposed on the at least one first hole (11) so as to divide the inflow of air into the intake and mixing chamber (10) in a corresponding way.

9. The analyzer according to claim 8, wherein said strip (27) is connected to the knob (17) by a lever mechanism (28) connected pivotably to the knob (17) at a predetermined distance from a pivot axis of the knob, in such a way that a rotation of said knob (17) corresponds to a translation of the strip (27) relative to the tube (3) in an axial direction (X) of the tube, from and towards said operating condition of division.

10. The analyzer according to claim 2, wherein said second nozzle (12) is provided at the end of a tubular body (13) which is slidably guided in the tube (3) and through which the gas to be supplied through the second nozzle (12) in said operational second position is made to flow, said actuator (15) comprising a cam (14) supported rotatably in the tube (3) and acting on said tubular body (13) to move it from and towards said operational second position, in opposition to a resilient return means (20), said cam (14) being operable by a control knob (17) accessible from outside the tube (3).
